(19) United States
(12) Patent Application Publication
(10) Pub. No.: US 2006/0124804 A1
(43) Pub. Date: Jun. 15, 2006

(54) Display and cable clip structure thereof

(75) Inventor: Shih-An Lin, Taipei County (TW)

Correspondence Address: BIRCH STEWART KOLASCH & BIRCH, PO BOX 747, FALLS CHURCH, VA, 22040-0747, US

(73) Assignee: BENQ CORPORATION

(21) Appl. No.: 11/291,982

(22) Filed: Dec. 2, 2005

(30) Foreign Application Priority Data
Dec. 15, 2004 (TW) 93138931

(51) Int. Cl. F16L 3/08

(52) U.S. Cl. 248/65

(57) ABSTRACT

A display and a cable clip thereof. The display, comprises a main body, a base, a support and a cable clip. The base supports the main body via the support connecting the main body and the base and comprising a depression with a lateral wall. The cable clip is disposed on the support, and the cable clip can be accommodated in the depression.

### BACKGROUND

The invention relates to a cable clip for a display, and in particular to a cable clip which can be accommodated in the display.

Displays are usually provided with several cables such as a power cable, a signal cable, a speaker power cable, a speaker signal cable and a USB cable. To put the cables in order, a cable clip is desirable. FIG. 1 depicts a conventional cable clip of a display. A cable clip 200 is disposed on the back of a support 300 of a display 500. Several parallel channels 201 are defined on the cable clip 200 made of elastic material such as rubber. The cables is clamped in the grooves 201 and held therein due to the elasticity of the rubber.

The cable clip 200 fixed on and projecting from the support 300, however, occupies a considerable space so that a larger packaging volume is needed. This incurs a higher shipping cost.

### SUMMARY

A display with a cable clip according to an embodiment of the invention comprises a main body, a base, a support and a cable clip. The base supports the main body via the support connecting the main body and the base and comprises a depression with a lateral wall. The cable clip is disposed on the support, wherein the cable clip is capable of accommodation in the depression.

The support comprises a first hole defined on the lateral wall, and the cable clip comprises at least a shaft inserted in the first hole, whereby the cable clip is rotatably disposed in the depression. The cable clip can be U-shaped. The shaft escapes from the first hole when two legs of the U-shaped cable clip are pressed, thereby releasing the cable clip from the support.

The cable clip comprises a protrusion, and the support further comprises a second hole defined on the lateral wall. The protrusion engages the second hole when the cable clip is accommodated in the depression.

A support of a display according to another embodiment of the invention comprises a groove adjacent to the lateral wall and extending into the support. The cable clip is slidably disposed in the groove and accommodatable in the depression.

The cable clip comprises a protrusion, and the support further comprises a first locating hole and a second locating hole defined in the groove. The protrusion engages the first locating hole when the cable clip is accommodated in the depression. The cable clip projects from the support when the protrusion engages the second locating hole.

In this embodiment, the cable clip can also be U-shaped. The shaft is released from the second locating hole when two legs of the U-shaped cable clip are pressed, thereby releasing the cable clip from the support.

### BRIEF DESCRIPTION OF THE DRAWINGS

The invention can be more fully understood by reading the subsequent detailed description and examples with references made to the accompanying drawings, wherein:

FIG. 1 is a schematic view of a conventional cable clip of a display;

FIG. 2 is a perspective view of a display according to an embodiment of the invention;

FIGS. 3a, 3b are partially enlarged views of FIG. 2;

FIG. 4 is a perspective view of a cable clip according to an embodiment of the invention;

FIG. 5 is an enlarged view of the depression of FIG. 4;

FIG. 6 is a perspective view of a cable clip according to another embodiment of the invention; and

FIGS. 7a and 7b are cross sections along line A-A of FIG. 6.

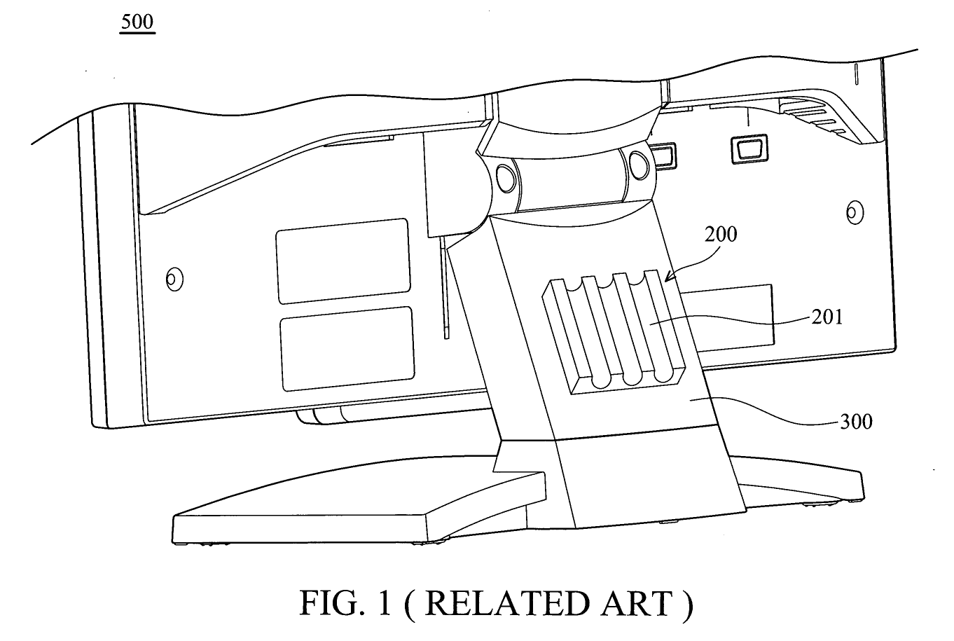

### DETAILED DESCRIPTION

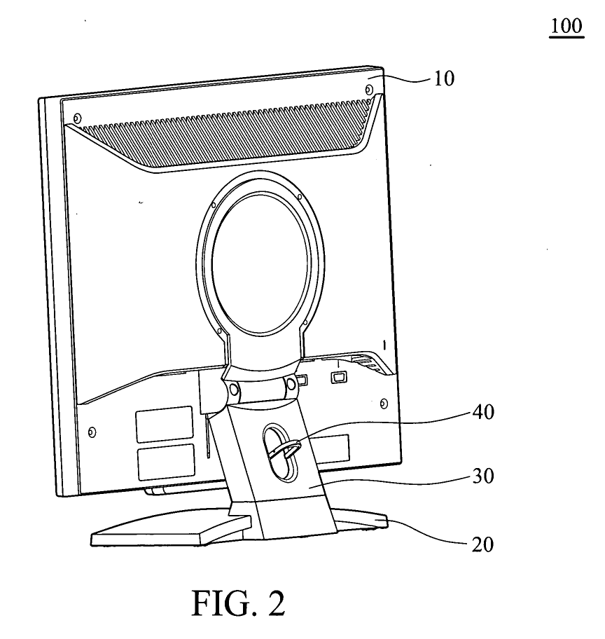

FIG. 2 depicts a display according to an embodiment of the invention. A display 100 comprises a main body 10, a base 20, a support 30 and a cable clip 40. The support 30 connects the main body 10 and the base 20. The cable clip 40 is disposed on the support 30 to clamp cables (not shown) used in the display 100.

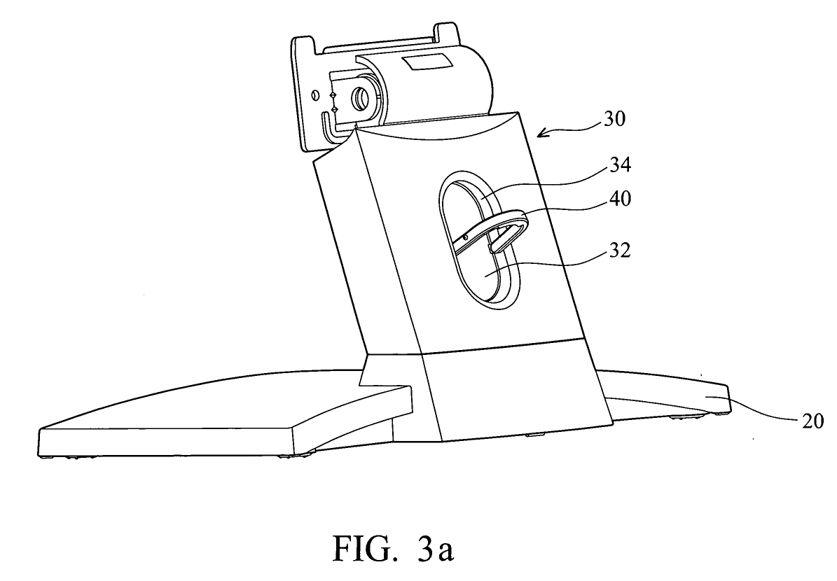

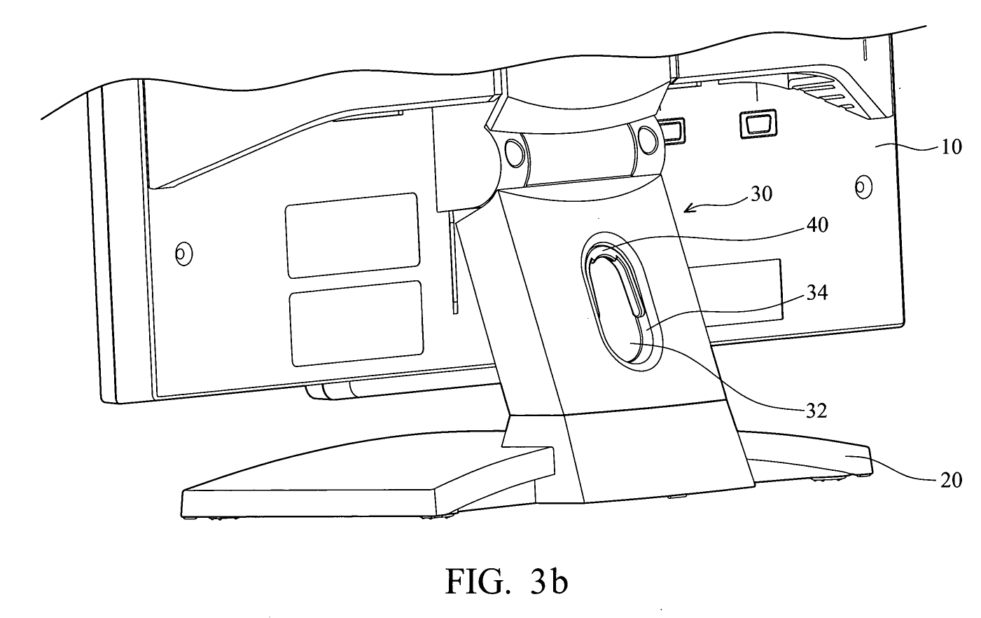

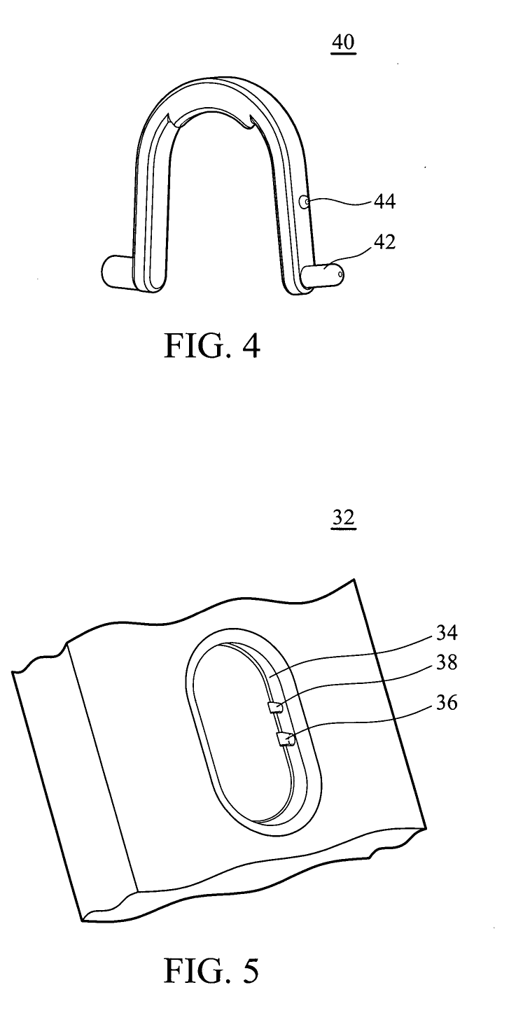

Referring to FIGS. 3a, 3b, a depression 32 is defined on the support 30, and the cable clip 40 is pivoted on a lateral wall 34 of the depression 32. Referring to FIGS. 4 and 5, the cable clip 40 is U-shaped. Each leg of the U-shaped cable clip 40 is provided with a shaft 42 and a protrusion 44 near the shaft 42. A first hole 36 and a second hole 38 are defined on the lateral wall 34 of the depression 32 corresponding to the shaft 42 and the protrusion 44 respectively. The cable clip 40 is pivoted on the lateral wall 34 of the depression 32 by means of the shaft 42 inserting into the first hole 36.

When the cable clip 40 is used to clamp the cables of the display 100, two legs of the U-shaped cable clip 40 are pressed to release the shaft 42 from the first hole 36, and the cable clip 40 is removed from the support 30. The cables are placed in the cable clip 40, and the cable clip 40 along with the cables is mounted into the depression 32 with the shaft 42 engaging the first hole 36 again. The cables are thus clamped between the cable clip 40 and the support 30. When not in use, the cable clip 40 is rotated to be accommodated in the depression 32 and secured therein by means of the protrusion 44 engaging the second hole 38.

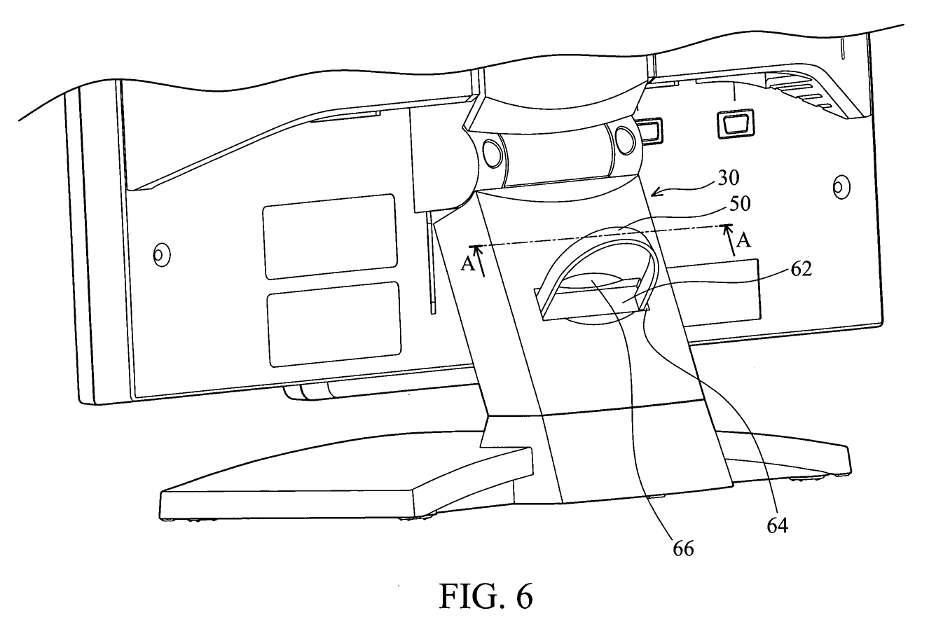

FIG. 6 depicts a cable clip according to another embodiment of the invention. A cable clip 50 is slidably disposed in a depression 62 with a lateral wall 64 of the support 30.

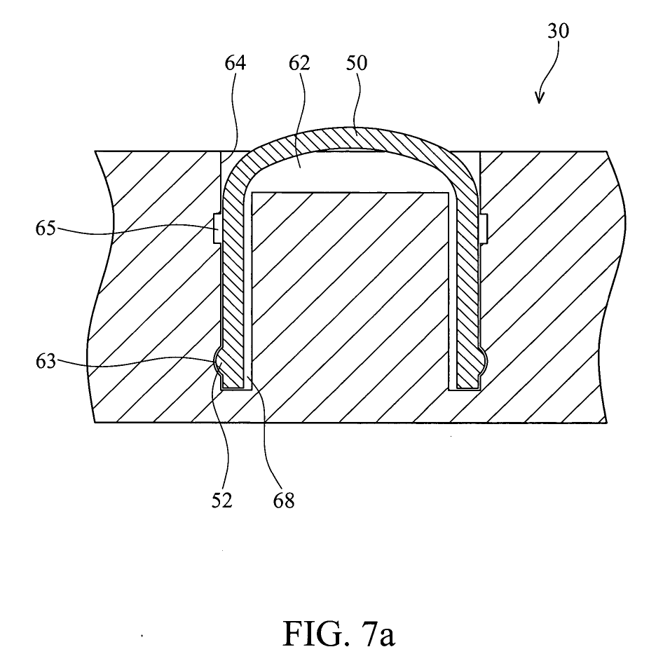

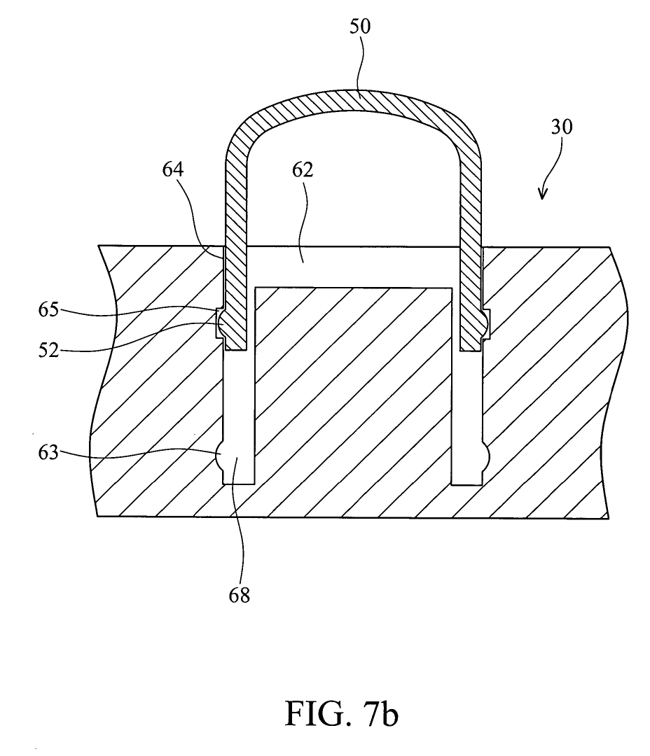

Referring to FIGS. 7a and 7b, the cable clip 50 is U-shaped and provided with a protrusion 52. A groove 68 defined in the support 30 is adjacent to the lateral wall 64. A first locating hole 63 and a second locating hole 65 are defined on the groove 68. When the cable clip 50 is pushed back to the depression 62, the protrusion 52 engages the first locating hole 63 due to the elasticity of the U-shaped cable clip 50, whereby the cable clip 50 is secured in the depression 30. As the first locating hole 63 has a smooth and round edge, the protrusion 52 can easily escape from the first locating hole 63 when the cable clip 50 is pulled up. The cable clip 50 projects from the support 30 and is positioned when the protrusion 52 engages the second locating hole 65 to clamp the cables.

When the cable clip 50 is used to clamp the cables, the U-shaped cable clip 50 is pulled and pressed on two legs thereof to escape from the depression 62. Next, the cables are placed in the cable clip 50, and the cable clip 50 along with the cables are inserted into and positioned in the groove 68 with the protrusion 52 engaging the second locating hole 65, whereby the cables are clamped between the cable clip 50 and the support 30. Each edge of the depression 62 has a concave portion 66 to facilitate the pull of the cable clip 50.

As the cable clip of the invention can be accommodated in the support of the display, the cable clip does not occupy additional space, and volume of the display is thus reduced. This can facilitate shipping.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cable clip structure for a display, comprising:
a support having a depression with a lateral wall;
a cable clip disposed on the support, wherein the cable clip can be accommodated in the depression.

2. The cable clip structure as claimed in claim 1, wherein the support comprises a first hole defined on the lateral wall, and the cable clip comprises at least a shaft inserted in the first hole, whereby the cable clip is rotatably disposed in the depression.

3. The cable clip structure as claimed in claim 2, wherein the cable clip is U-shaped, and the shaft is released from the first hole when two legs of the U-shaped cable clip are pressed, whereby the cable clip is released from the support.

4. The cable clip structure as claimed in claim 2, wherein the cable clip comprises a protrusion, the support further comprises a second hole defined on the lateral wall, and the protrusion engages the second hole when the cable clip is accommodated in the depression.

5. The cable clip structure as claimed in claim 4, wherein the cable clip is U-shaped, and the shaft is released from the first hole when two legs of the U-shaped cable clip are pressed, thereby releasing the cable clip from the support.

6. The cable clip structure as claimed in claim 1, wherein the support further comprises a groove adjacent to the lateral wall and extending into the support, the cable clip is slidably disposed in the groove and can be accommodated in the depression.

7. The cable clip structure as claimed in claim 6, wherein the cable clip comprises a protrusion, the support further comprises a first locating hole defined on the groove, and the protrusion engages the first locating hole when the cable clip is accommodated in the depression.

8. The cable clip structure as claimed in claim 6, wherein the support further comprises a second locating hole defined in the groove, and the cable clip projects from the support when the protrusion engages the second locating hole.

9. The cable clip structure as claimed in claim 8, wherein the cable clip is U-shaped, and the shaft is released from the second locating hole when two legs of the U-shaped cable clip are pressed, whereby the cable clip is released from the support.

10. A display, comprising:
a main body;
a base supporting the main body;
a support connecting the main body and the base, and comprises a depression with a lateral wall;
a cable clip disposed on the support, wherein the cable clip can be accommodated in the depression.

11. The display as claimed in claim 10, wherein the support comprises a first hole defined on the lateral wall, and the cable clip comprises at least a shaft inserted in the first hole, whereby the cable clip is rotatably disposed in the depression.

12. The display as claimed in claim 11, wherein the cable clip is U-shaped, and the shaft is released from the first hole when two legs of the U-shaped cable clip are pressed, whereby the cable clip is released from the support.

13. The display as claimed in claim 11, wherein the cable clip comprises a protrusion, the support further comprises a second hole defined on the lateral wall, and the protrusion engages the second hole when the cable clip is accommodated in the depression.

14. The display as claimed in claim 13, wherein the cable clip is U-shaped, and the shaft is released from the first hole when two legs of the U-shaped cable clip are pressed, whereby the cable clip is released from the support.

15. The display as claimed in claim 10, wherein the support further comprises a groove adjacent to the lateral wall and extending into the support, the cable clip is slidably disposed in the groove and can be accommodated in the depression.

16. The display as claimed in claim 15, wherein the cable clip comprises a protrusion, the support further comprises a first locating hole defined on the groove, and the protrusion engages the first locating hole when the cable clip is accommodated in the depression.

17. The display as claimed in claim 15, wherein the support further comprises a second locating hole defined on the groove, and the cable clip projects from the support when the protrusion engages the second locating hole.

18. The display as claimed in claim 17, wherein the cable clip is U-shaped, and the shaft is released from the second locating hole when two legs of the U-shaped cable clip are pressed, whereby the cable clip is released from the support.
